(19) United States
(12) Patent Application Publication
(10) Pub. No.: US 2014/0109755 A1
(43) Pub. Date: Apr. 24, 2014

(54) DECOY MATERIAL PACKAGE, A DISPENSER AND A METHOD FOR DISPENSING DECOY MATERIAL

(71) Applicant: SAAB AB, Linkoping (SE)

(72) Inventors: Gloria Stenfelt, Segeltorp (SE); Marie-Louise Friede, Hasselby (SE); Gunnar Byström, Kungsangen (SE)

(73) Assignee: SAAB AB, Linkoping (SE)

(21) Appl. No.: 14/099,575

(22) Filed: Dec. 6, 2013

Related U.S. Application Data
(62) Division of application No. 13/148,987, filed on Nov. 14, 2011.

(51) Int. Cl. F41H 11/02; B64D 1/02

(52) U.S. Cl. CPC F41H 11/02; B64D 1/02
USPC 89/1.51

(57) ABSTRACT

A decoy material dispenser. An elongated decoy material package includes an elongated strip-shaped container including a plurality of depressions receiving decoy material. A cover covers and hermitically seals the container. A gripping portion cooperates with a feeder including a gripper. A housing includes a storage section that stores the package. An outlet releases the decoy material. A waste collection section collects empty packages. A feeder device feeds the package from the storage section to the outlet and to the waste collection section. The feeder device includes a feeder and a driver. The feeder includes a gripper that cooperates with the gripping portion. The package is oriented in the dispenser such that the cover is directed towards the outlet and the container is directed away from the outlet. A force applicator applies pressure to the container. A package opener opens, cuts or perforates the package to release the decoy material.

### TECHNICAL FIELD

The present invention relates to a field of storing and dispensing decoy material and more specifically to a decoy material package, decoy material dispenser and method of dispensing the decoy material.

### BACKGROUND ART

Today, civil aircrafts have a poor capability of defending themselves against outside threats. Until now no affordable and durable countermeasure technology has been available for commercial use. One of the most feared risks is the Manpad (Man-Portable Air Defence) threat of IR-guided missiles, especially nearby airports, where aircrafts fly low above areas that are practically impossible to secure against portable short-range missiles.

There are many defensive countermeasures available and IR guided anti aircraft missiles can be mislead in many ways. These systems have been mainly adapted for use in military aircrafts. One of the most common procedures is to dispense pyrotechnic flare decoys from a target aircraft. Since the heat developed from the decoy is larger than the heat from the jet engine exhaust of the aircraft, an IR guided missile will track the dispensed flare decoy instead. Chaff decoys can be dispensed in a similar way, but they form a cloud of small thin strands of aluminium behind the aircraft. The length of these thin strands is half the wavelength of the missile radar. The approaching missile system detects this as a group of secondary targets and the missile will accordingly change its route. Chaff decoys are available contained in different kinds of inserts and cartridges, such as cartridges for pyrotechnic dispensers.

The requirements for civil use are, however, somewhat different and the systems used in military aircrafts need to be adapted not only to a civil aircraft platform, but also to a large scale market and a secure handling of the decoys has to be ensured. Also environmental aspects have to be considered. If a decoy package is dispensed into nature, an environmentally friendly package material should be used.

Experiences from existing military systems show that there are many false alarms that cause decoys to be dispensed. Large amounts of packages lying around on the ground can result in environmental problems. Considering that there are much fewer military aircrafts than civil aircrafts in the air it is clear that systems for dispensing decoys used for military aircrafts cannot be implemented on civil aircrafts right away. Also safety measures to prevent dispensing of decoy material while the aircraft is still on the ground should be considered and safety in the air is of course important. It is also necessary to ensure that for instance pyrophoric materials do not cause fire inside the aircraft in case a package containing the material breaks by accident. One major problem that has to be solved for all new or adapted dispensers for civil aircraft platforms is the fire safety inside the decoy package dispenser. No risk of damaging an aircraft can be allowed, as this would undermine the overall purpose of installing a decoy system, i.e. to protect the civil aircraft.

WO2004/070310 discloses a process and pack for heat-generating counter-measures. The pack comprises a container and a lid and a sealable inlet and a sealable outlet. The lid is welded to the container so as to achieve hermetic sealing. The whole pack is intended to be dispensed and will remain in the environment after release of the contents thereof.

Decoy material packages and dispensers are at the moment expensive to produce and are not adjusted to a large-scaled production. Further, the packages and the dispensers are not adjusted to the safety requirements for civil use and to the environmental requirements. Therefore, it would be advantageous if a decoy material package and dispenser could be adjusted to these needs.

The object of the present invention is to provide a safe, economical and environmentally friendly decoy material package and dispenser which can be simply operated for example by civil aircraft personnel. One further object is to provide a decoy material package which fulfils safety requirements for civil aircrafts and which can be collected and taken care of after release of the decoy material.

Further objects and benefits will be apparent from the description below.

### SUMMARY OF THE INVENTION

The present invention relates to a decoy material package for use in a decoy material dispenser which package comprises an elongated container portion which is in the form of a strip and which comprises a plurality of depressions which are to be filled with decoy material. The package further comprises a cover portion, which is sealed to the container portion, when the depressions have been filled with the decoy material, and which covers the container portion; whereby the decoy material is hermetically stored in the depressions of the package. The package also comprises a gripping portion for cooperation with a feeding means comprising gripping means in the decoy material dispenser.

The decoy material package of the present invention fulfils safety requirements for decoy material packages since the decoy material does not come into contact with surrounding air. Due to the gripping portion which cooperates with a feeding means comprising gripping means in a dispenser, the package can be dispensed in an effective, simple and secure way. Further, the package can be dispensed in such a way that at least a major part of the package material can be collected and handled in an environmentally friendly way. Further benefits obtained with the present package will be apparent from the description below.

The package material may comprise an oxygen barrier which further improves the security of the package since the decoy material does not come into contact with oxygen in the air.

The individual depressions which protrude outwards from the container portion of the package may have a rounded form, i.e. edges of the depressions are not sharp. The rounded form of the depressions enables an easier emptying of the material from the depressions, and it is also possible to avoid the material being stuck inside the corners of the depressions during and after release of the material.

The gripping portion of the package preferably comprises holes or recesses that coincide with the gripping means of the feeding means in the dispenser. Through the holes or recesses it is possible to arrange feeding of the package in a simple, safe and economical way. The holes or recesses ensure that the package can follow a pre-determined path inside the dispenser. The holes and/or recesses also enable that the dispensing of the package is as accurate as possible, i.e. it is simple to start and stop and the depressions can be guided to an exact dispense position inside the dispenser.

The gripping portion is preferably located in the container portion. Thereby it can be assured that, e.g. the holes of the gripping portion cannot be accidentally placed on top of the decoy material. The gripping portion may be arranged along one or both side edges of the package, depending on the design of the feeding means and whereby e.g. an accidental folding of the package can be avoided.

The present invention further relates to a decoy material dispenser for a vehicle for dispensing decoy material from the elongated decoy material package. The dispenser comprises a housing in which a storage section for storage of the decoy material package is arranged. The dispenser further comprises a dispensing outlet for releasing the decoy material and waste collection section for collection of the empty package material. A feeding device is arranged for feeding the elongated package from the storage section to the dispensing outlet and further to the waste collection section. The feeding device comprises feeding means and driving means and the feeding means comprises gripping means that cooperate with the gripping portion of the package. The package is oriented in the dispenser such that the cover portion of the package is directed towards the dispensing outlet and the container portion is directed away from the outlet. The dispenser further comprises a forcing means that applies pressure to the container portion of the package. Also, a package opening means is provided for opening, cutting or perforating the package so that the decoy material stored in the package can be released from the package.

Through the present dispenser a risk for an accidental breakage of the package during the feeding operation is minimized because the package can follow a pre-determined path inside the dispenser since the feeding means and the gripping portion of the package cooperate with each other. The emptied package can be collected for a further handling and thereby none or only a minor amount of the packaging material is dispensed to the nature. To further facilitate the collection of the emptied package the waste collection section may comprise a means for reeling up the emptied decoy material package.

The gripping means may comprise cogs being arranged so that they coincide with holes or recesses of the gripping portion of the package. Through this arrangement it is assured in a simple, effective and economical manner that the feeding of the package is as smooth as possible and that the package can follow a predetermined path through the dispenser. Therefore also a possibility for a breakage is further minimized.

The dispenser comprises the package opening means which may be a U-shaped knife which is able to ensure that the cover portion material of the package is cut or perforated so that one edge of the cover portion covering the depression is not cut and thereby the cover material can be collected. Accordingly, this enables that it is possible to collect all the packaging material. The package opening means is preferably located in connection with the dispensing outlet so that the decoy material package will not be cut and come into contact with air before leaving the dispenser.

The feeding device and/or the forcing means are preferably driven with at least one electro-mechanical engine which is coupled to a control system of the vehicle. By coupling the driving means to the control system of the vehicle, the dispenser or at least parts of it, can be controlled with the same control system as the whole vehicle. For example if the vehicle is an aircraft, the dispensing of the decoy material can be prevented by means of the control system of the aircraft when the aircraft is located on the ground. Through such an arrangement, the security aspects of the dispensing are further improved.

The feeding device feeds the package towards a dispenser outlet, and is preferably driven with an electro-mechanical engine which can be coupled to a control system of the vehicle. At least the feeding means may be driven with the electro-mechanical engine. The driving means may be aimed to drive only the feeding means or it may be common to several devices in the dispenser, such as for example the forcing means or the means for reeling up or unreeling the package.

The present invention further relates to a method for dispensing decoy material which comprises feeding the decoy material package from a storage section by means of a feeding device comprising a driving means and feeding means. The feeding means comprises gripping means that cooperate with a gripping portion of the package. At least one individual depression at a time is forced by means of a forcing means towards the opening means which opens, cuts or perforates the package. The decoy material is released from the depression by means of the forcing means and the forcing means is then removed from the contact with the package. The package is then moved by means of the feeding means so that the next depression is placed in a dispense position. The emptied decoy material package is collected to a waste collection section. The steps are repeated until the desired amount of the decoy material has been dispensed.

### DETAILED DESCRIPTION OF THE INVENTION

The decoy material package and dispenser are mainly aimed for use in a vehicle. The vehicle can be any vehicle, such as an aircraft, for example a civil aircraft, truck, or a boat. It can be used also in military vehicles.

The decoy material can be any decoy material that can mislead a threat against a vehicle, such as missiles. Examples of suitable decoy materials are for example heat-generating countermeasures, such as pyrophoric materials, and chaff. One type of suitable decoy material is called CAD, Combustible Area Decoy, which burns when it is subjected to oxygen. When pyrophoric decoy material reacts with oxygen, it fully combusts and leaves no traces. Therefore, only the package has to be considered from an environmentally friendly point of view.

The package is preferably made of a relatively strong material and it protects the active decoy material content against a contact with the surrounding air, temperature changes, vibrations, moist, and against accidental impacts. Suitable package materials can be for example plastics, which can comprise a layer of another material, such as a layer of a different type of plastic, and/or a textile and/or a metal layer, etc. Examples of suitable plastic materials are acrylics, polyesters, silicones, polyurethanes and halogenated organic plastic materials, such as, for example polyester films, polyamine films, ethylene vinyl alcohol (EVOH), polyethene and polyethylene terephthalate. The package material advantageously comprises an oxygen barrier. The thickness of the material in the container and cover portion may be for example within 50-2000 μm. The material thickness of the container portion is advantageously higher than that of the cover portion to provide sufficient stability.

The package comprises depressions which may be rigid enough to withstand a variable pressure depending on for example the altitude of the aircraft and the temperature surrounding the package. The filling grade of the depressions affects the deformation of the package as the pressure varies. The more decoy material in the depressions of the package the less the package deforms and vice versa. Therefore, it is preferable that the depressions are filled to a maximum grade. The individual depressions, which protrude outwards from the container portion, can have a rounded form, i.e. the edges of the depressions are not sharp. The edges or the depressions can be rounded or the depressions can have a form of from about ¼ of a sphere to about a half of a sphere or as desired. A rounded form of the depressions enables an easier emptying of the decoy material from the depressions.

The gripping portion of the package may comprise means of any suitable design that can cooperate with the gripping means of the feeding means in the dispenser. For example holes or recesses that coincide with clogs of the feeding means can be used due to the simple and economic design of both the package and the feeding means. The cooperation means may be placed in both the container portion and the cover portion, the container portion being preferred.

The package may be produced by a method which comprises first heating the flexible sheet material for the container portion and then placing the container portion material over positive moulds forming the depressions in the container portion. The material is then vacuum or heat moulded and then cooled. The holes or recesses in the gripping portion may be provided for example by means of perforating either before or after the moulding. After the depressions have been formed, decoy material is placed into the depressions. Before sealing the depressions, gas is extracted from the depressions. It can be done before or simultaneously with the sealing, which can be done e.g. by welding or gluing the cover portion to the container portion. The cover portion is welded or glued onto the container portion in an airtight manner so that a hermetic package for the decoy material is formed.

The decoy material package according to the present invention provides hermetic storage for the decoy material, which might otherwise react with the oxygen in the surrounding air. The present package also enables dispensing of the decoy material in an environmentally friendly manner. Due to the design of the package, the collection of the packaging material is enabled.

While an aircraft is on the ground, a false dispense alarm should either lead to that no dispense at all or that the package is fed without releasing the decoy material. The first option forces one to control the forcing means, which is preferably controlled directly via the electro-mechanical engine by a missile warning system, while the latter option can be solved by moving the knife away from the outlet. Systems to prevent dispense on the ground for military aircrafts are today mainly based on weight on wheel sensors. Another system is a mechanical or electro-mechanical arrangement in which a knife can be connected to a wind indicator which is affected by the stream outside the vehicle which provides the movement of the knife; when the aircraft stands still the indicator is vertical due to gravity, and when in flight the indicator rises and moves the knife. The knife should be activated during the whole flight so that the landing speed, or stall speed, of the aircraft decides the activation moment. The indicator should not be influenced by wind on the airport and preferably does not reach an activation angle below a velocity of about 25 m/s, which is well below the stall speed for a civil aircraft.

If, for some reason the package opens inside the dispenser, it is of great importance that no fire occurs or that a fire does not spread. There are available systems for suppressing fires in engines and cargo compartments. Normally, a thermal sensor detects an overheated condition and a fire suppression agent, such as for example bromotrifluoromethane, water mist/nitrogen system, pentafluoroethane or bromotrifluoropropene can be discharged from pressurized bottles. Additionally, technology with environmentally friendly and inflammable isolation materials is available. Isolation materials can be used to coat the inside of the dispenser housing, to reduce both the damage on the magazine walls and the temperature behind the walls. A thermal or a smoke sensor can be placed inside the dispenser to warn the pilot and to trigger the fire suppression system.

The requirements of safe handling of the decoys and easy loading for the flight personnel constrain the ways to design the dispenser. If a flight attendant has to be able to load the dispenser safely, it is convenient that the entire dispenser is removable. Hence, the decoy package can already be loaded in the dispenser outside the aircraft. Later, the dispenser is put into place by the flight attendant. Loading the decoys into the dispenser can be consequently performed by the delivery firm of the dispenser.

Further in the dispenser, due to the preferable position of the knife, it is also preferable to include the knife in the dispenser. Otherwise it could be in a way when putting the dispenser into the aircraft. A knife can also be worn out and has to be checked from time to time for damages; so it is advantageous to do this while loading the decoy package into the dispenser.

Given that the holes in the decoy package should coincide with the cogs on the feed cylinder, it is preferred that also the feed cylinder is placed inside the removable dispenser.

The housing preferably covers and protects at least the decoy package, the feed cylinders and the knife while transported to and while installed in the vehicle. The decoy material package is loaded into the magazine and the holes at the beginning of the strip are hooked onto the feed cylinder. The housing can comprise an inspection window through which it can be checked if the package is in the right position.

The surfaces inside the magazine are preferably smooth to prevent the package from being ripped open on sharp edges. To more easily keep the package in the right sideways position it can be fed through a slot or other means that can guide the package.

The forcing means and the gear driving means can be chosen not to initially be enclosed within the housing. Therefore, the driving means and the forcing means can be constructed so that they fit into coupling means located inside the housing, e.g. they fit corresponding slots on the housing when installing the dispenser into the vehicle. However, the forcing means and/or the driving means can be made a part of the magazine as well. Preferably, at least one electro-mechanical engine, which can drive the feeding means and/or the forcing means is provided and can be coupled to the dispenser by any suitable means known to the person skilled in the art.

Civil airliners put larger demands on decoy dispensing systems than the military. Through the present package a simple and safe design is provided, so that an easy and fast mass production of the decoy packages can meet the demands for a large scale market. Flight personnel are able to load the decoys, which keeps the installation costs low. One of the major advantages with the present invention is that about all of the package material can be collected inside the dispenser and thus an environmentally friendly solution is found. In addition, the package material and the quality of the seal can be tailored to withstand impacts, flexions, moisture and vibrations.

The invention is now described in more detail with the accompanying drawings. The drawings are only to be regarded as examples of the invention without limiting the scope of the invention defined in the appended claims.

### BRIEF DESCRIPTION OF THE DRAWINGS

FIG. 1 shows schematically the decoy material dispenser according to the present invention.

FIG. 2 shows a detailed view of the feeding device and forcing means according to one embodiment of the invention.

FIG. 3 shows a detailed view of the cutting device according to one embodiment of the invention.

FIG. 4 shows schematically the dispensing procedure according to the invention.

FIG. 5 shows schematically a view from above of the package according to the invention.

FIG. 6 schematically shows in more detail a depression in the container portion of the package and a weld area.

FIG. 7 shows a detailed view of the package according to the invention.

FIGS. 8a-8c show depressions in the container portion which have a rounded form and which are filled with different decoy material leaf sizes according to the invention.

FIGS. 9a and 9b shows schematically the manufacturing procedure for the package according to the invention.

### DETAILED DESCRIPTION OF THE DRAWINGS

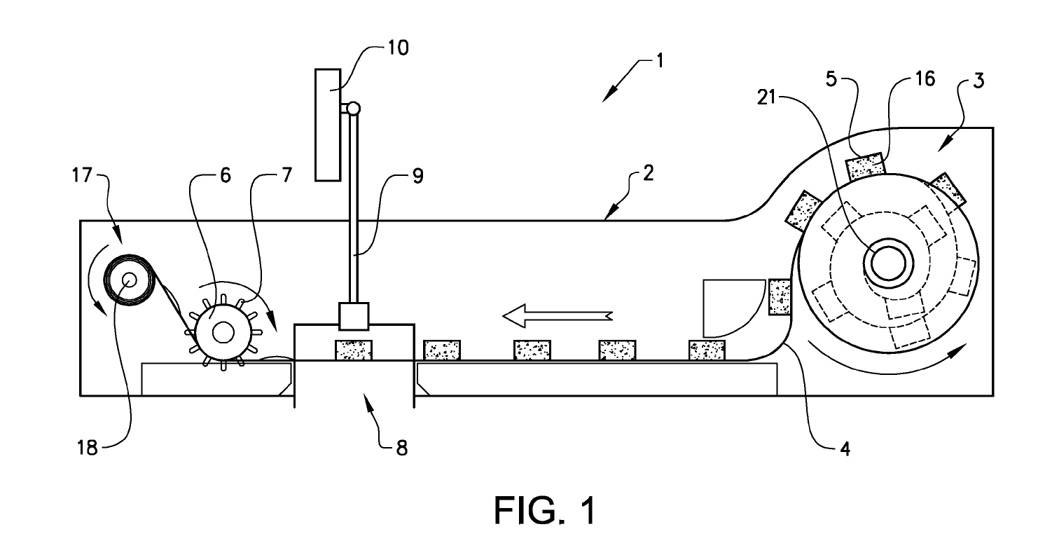

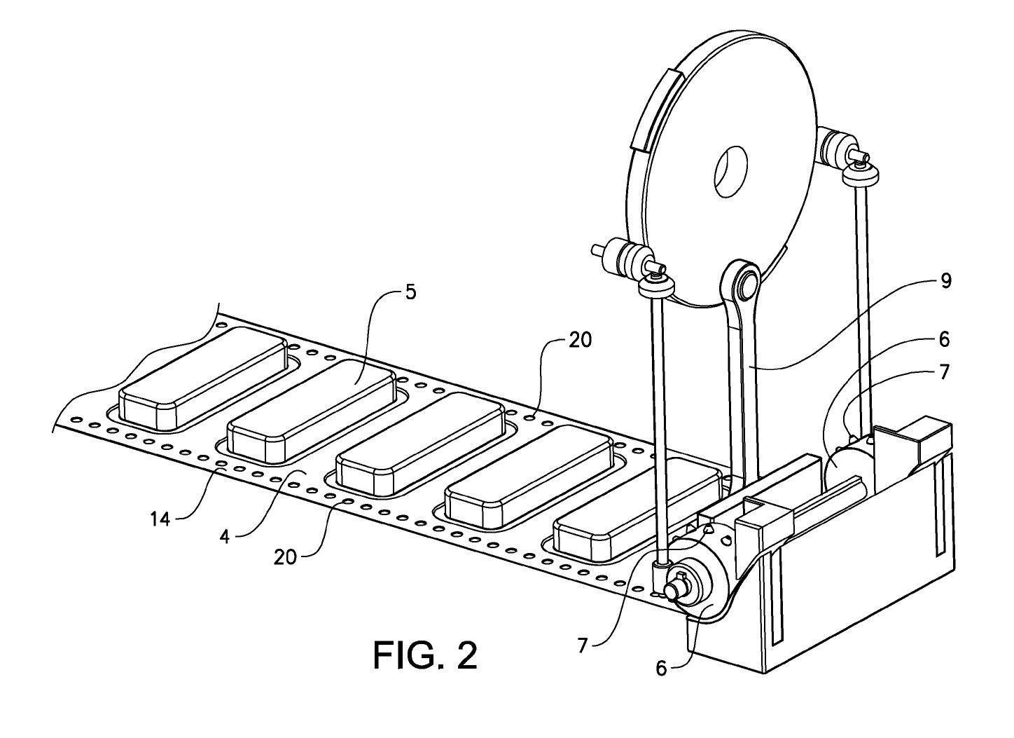

In FIG. 1, a dispenser 1 according to the invention is schematically shown. The decoy material 16 is contained in the depressions 5 of a package 4. The package 4 is stored in a storage section 3 and is placed on a means 21 which in the FIG. 1 is a rotatable reel. The design and function of the means 21 may vary as long as the package 4 can be stored and placed in such a manner that the feeding of the package is enabled. The means may be for example a reel, a rotatable reel which may be driven and which can thereby facilitate the feeding of the package. It can also be e.g. a container.

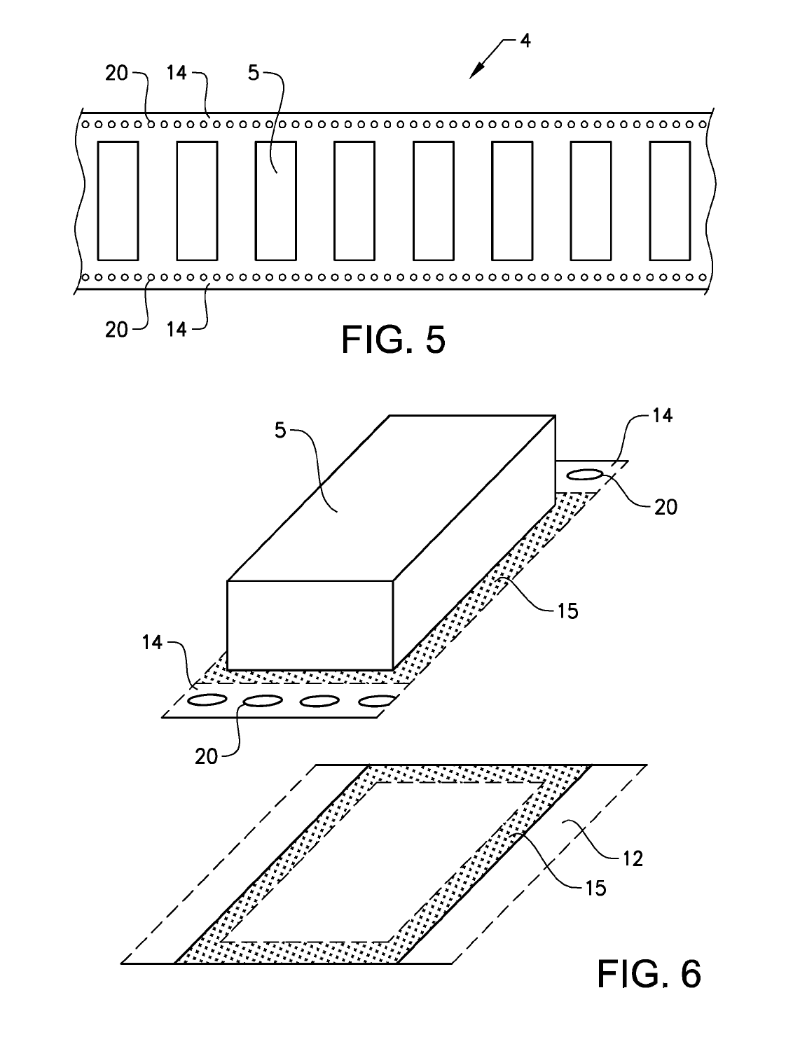

Further in FIG. 1, the package 4, which has the form of a strip, is fed from a reel 21 towards an outlet 8 on the left by means of a feeding device which comprises feeding means 6 in form of two cylinders 6 (only one is shown). The feeding cylinder 6 comprises clogs 7 which can grasp holes 20 in the gripping portion 14 of the package 4, see e.g. FIG. 5. To prevent the folding of the package, the feed cylinders are preferably placed after the dispense outlet 8 in the feeding direction.

The feeding cylinders 6 may be driven with a separate driving means or with a common driving means 10 for both the feeding cylinders 6 and forcing means 9. The forcing means is preferably e.g. a piston 9, as shown in the figures. The driving means 10 can be e.g. an electro-mechanical engine. To be able to drive the feeding cylinders 6 and the piston 9 with a common electro mechanical engine, a gear connection between the feed cylinders 6 and the electro mechanical engine 10 can be arranged so that the decoy package 4 can be fed towards the piston 9 at the right time. The decoy package 4 can be fed forwards each time the piston 9 moves up after having compressed the package. It should be noted that the forcing means 9 may have any form or design as long as it can force the package towards the outlet 8. The forcing means 9 may be enclosed within the dispenser or it may be located outside the housing of the dispenser 1. In that case, the dispenser 1 should comprise coupling means that couples the external forcing means to the dispenser 1.

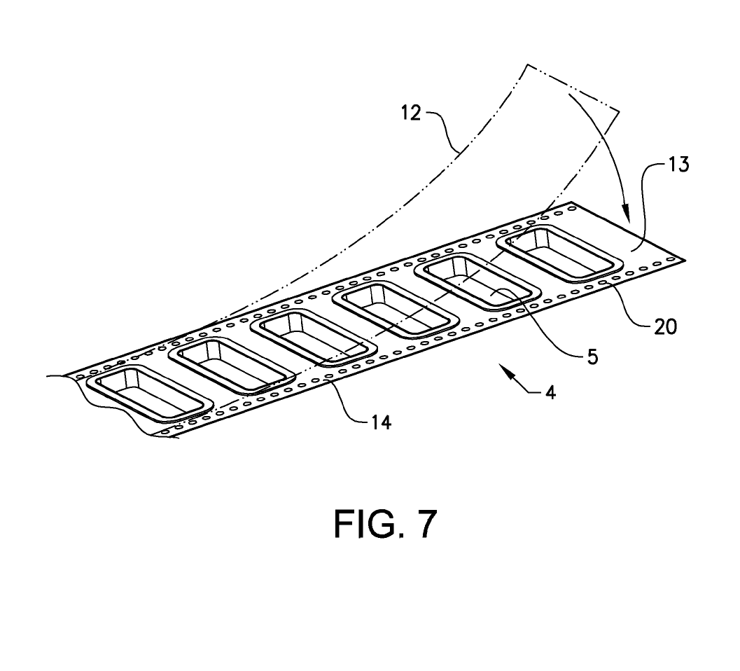

The package 4 is preferably made of a relatively strong material that protects the active decoy material content 16 from a contact with the surrounding air, temperature changes, vibrations, moist, and against accidental impacts. The package 4 may be formed as shown in the FIG. 7, so that it comprises a container portion 13 and a cover portion 12 which are strong enough to withstand impacts and therefore also withstand the pressure from the forcing means 9 alone. Therefore, the package 4 and/or the seal, e.g. a welded or glued joint 15, as shown in FIG. 6, between a container portion 13 and cover portion 12 is at least partially released, cut, perforated or otherwise weakened before the decoy material 16 is released from the package 4.

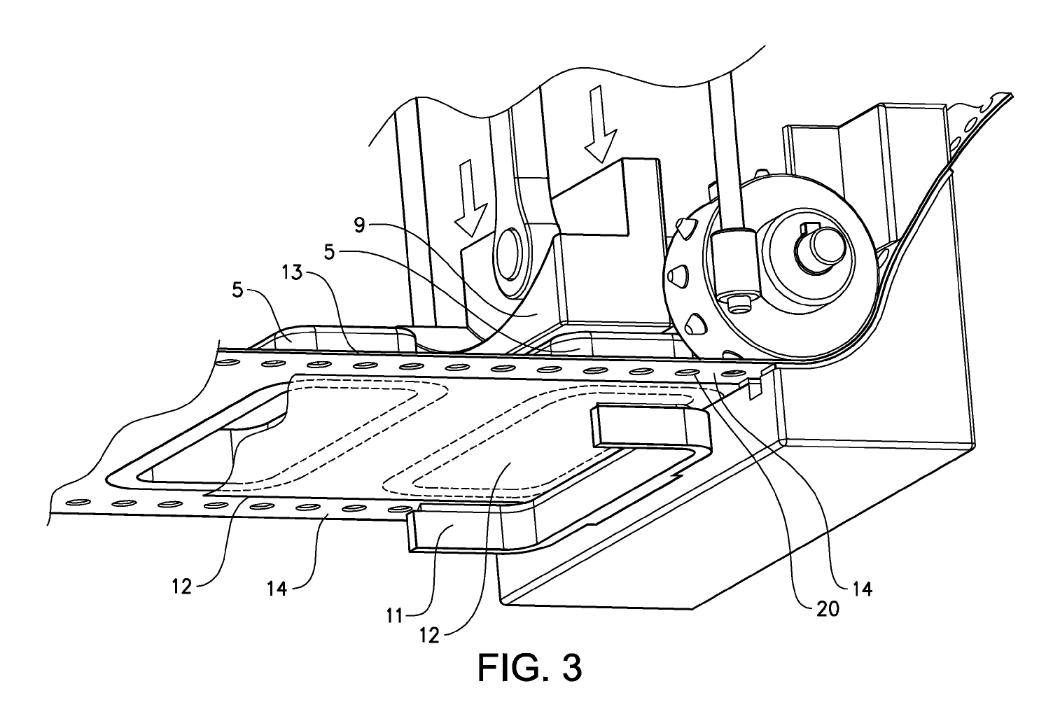

In FIG. 3, an opening means 11 suitable for use in the dispenser 1 is shown. The opening means 11 partially cuts the cover portion of the package and has a form of a U-shaped knife. The U-shape of the knife 11 prevents that the entire cover portion 12 under the decoy material 16 is cut off. It is also possible to use other available arrangements that enable at least a partial release or weakening of the cover portion, e.g. glue that dissolves when it comes in to contact with electricity.

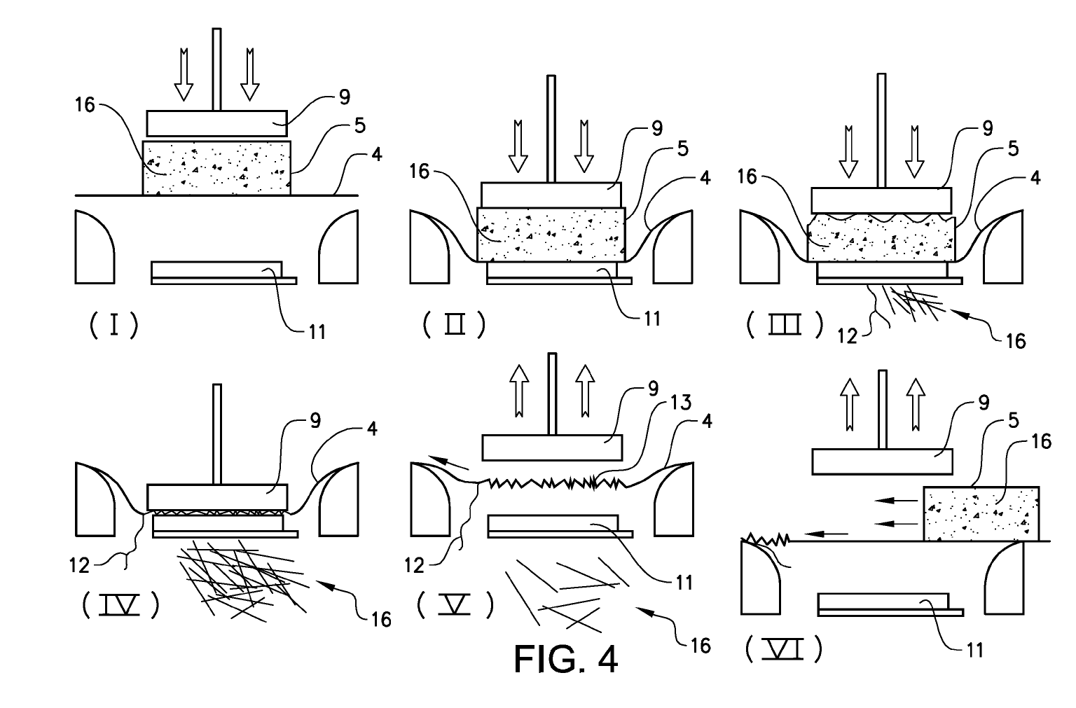

The dispensing procedure is shown schematically in the series of figures (I)-(VI) in FIG. 4. The decoy material 16 inside the depression 5 can be released by at least partially cutting the cover portion 12 of the package 4 and applying pressure by means of the forcing means 9 on top of the depression 5. After release of the decoy material 16 the forcing means 9 moves upwards and a new depression 5 is fed to the dispense position. The decoy material 16 is released by means of the pressure from the piston 9 after the cover portion 12 has been perforated by means of the knife 11. The knife 11 is preferably supported and does not move in the dispense direction or sideways. The knife 11 does not therefore move when the forcing means 9 pushes the package 4 towards the knife edge. To cut or perforate the package 4, the cover portion 12 is brought into contact with the knife 11. This happens as the forcing means 9 presses on the depression 5 of the package 4. As soon as the cover portion 12 of the decoy package reaches the upper edge surface of the knife, the piston starts to compress the depression 5 and the decoy material 16 is released by pushing it out through the open cut hole. As shown in the embodiment of the FIG. 3 due to the u-shape of the knife 11, the cover portion 12 is still attached to the package 4 when it is fed forwards. The forcing means 9 has its turn point just above the knife edge and while the forcing means 9 moves up the package 4 is fed forwards. A new depression 5 follows for the next dispense. In that way the feeding procedure occurs at a certain interval in the piston motion which is useful for the design of the feeding device.

The decoy material may be also released as close to a free-stream as possible. Instead of having a knife under the package, a small and sharp device can be put inside the depression between the decoy material 16 and the cover portion 12. This device can make an initial rupture to the cover portion 12 when pressure is applied on the depression. The material of the sharp device is preferably environmentally friendly, since it is dispensed together with the decoy material.

Returning now to FIG. 1, the emptied package is collected after release of the decoy material 16 to a collection section 17 of the dispenser 1. According to one embodiment of the invention the collection section 17 may comprise means 18, e.g. a reel, on which the emptied package is collected. The reel is preferably rotatable and it can be driven by a separate or common driving means with the feed cylinders and/or the forcing means and/or it can be mounted in bearings such that it rotates when force is applied to the reel.

A decoy material package 4 is useable in the dispenser 1 of the present invention. As shown e.g. in FIGS. 5-7 in more detail, the package 4 comprises an elongated container portion 13 in form of a strip. The decoy package is preferably made of a mouldable airtight flexible packaging material which may comprise an oxygen barrier. The container portion 13 comprises a plurality of individual depressions into which the decoy material 16 is placed. The package 4 further comprises an elongated cover portion 12, which is also made of an airtight flexible material which may comprise an oxygen barrier. The cover portion 12 is sealed by welding or gluing together with the container portion 13 to cover the container portion as shown in FIG. 6 in which the weld area is marked as 15. The decoy material 16 is thereby hermetically sealed into the depressions 5 of the package 4. The package 4 comprises a gripping portion 14 comprising holes 20 for cooperation with the clogs 7 of the feeding cylinder 6. The holes 20 can be located in the container portion 13 as shown by the FIG. 7. The distance between the holes 20 in the package 4 is preferably proportional to the distance between the depressions 5; i.e. a pitch, so that the depressions 5 can be placed at a right dispense position. Preferably, the outer arc length of the feed cylinder 6 is proportional to this pitch, such that when the cylinder 6 rotates one lap, the next depression is fed to the dispense position.

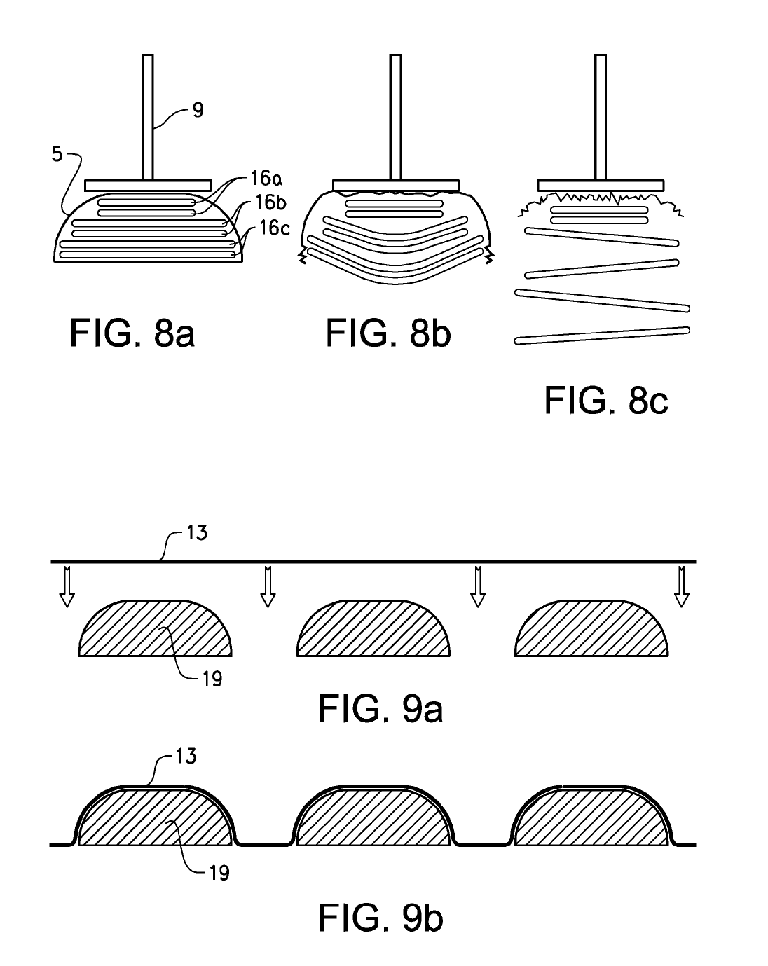

A compression of the package can cause the edges to fold. Thus, some of the active decoy material, such as pyrophoric leaves, could be pinned inside the package and could cause a fire inside the dispenser 1 in the collecting section 17. To prevent this, the individual depressions, which protrude outwards from the container portion 13, may have a rounded form as shown in FIGS. 8a-8c. The form of the blisters may also be a form of from about ¼ of a sphere to about a half of a sphere but this can be varied even more depending on the desired design of the blister. Then, the pyrophoric leaves 16a, 16b and 16c should preferably have at least two different sizes and/or shapes and the large ones 16c, which are placed near the bottom are most likely pushed out by the small leaves 16a and 16b above. By arranging the depressions 5 so that they have a rounded form, i.e. edges are not sharp, the package can even capture more decoy material 16, since it can be filled to a larger grade. Changes in width and height which do not decrease the total volume are also possible if the opening procedure thereby is optimized.

The package 4 can be for example vacuum moulded, as shown in FIGS. 9a and 9b. A plastic film is placed inside a vacuum machine, where the film first is heated to become more flexible. Then the plastic is placed over positive moulds 19 and vacuum suction through small holes between these moulds is initiated to form the film into a container portion 13 comprising depressions 5. Afterwards the plastic is cooled down. The decoy material, such as a pyrophoric material, is placed inside the depressions 5 in an inert gas atmosphere under a under pressure. Finally, the cover portion 12 is sealed by welding or gluing onto the container portion 13 by means of welding by e.g. soldering-iron or for example by applying an adhesive on the weld area 15.

Each depression can have a volume of from about 10 cm³ and preferably at least about 15 cm³. However the volume can be adjusted depending on the decoy material so that enough material can be dispensed from each depression. The seal can be made strong such that it meets a requirement of withstanding a drop from about 4 m.

The depressions may have rounded form as shown in FIG. 8. For example, with two different shapes of decoy material leaves and with an edge radius of 5 mm the inside of the package can be at least 80 mm wide when the length and height are chosen to be 27 mm and 10 mm respectively.

Considering that the space between all packages must be flexible, the distance between all packages can be at least one package length. Furthermore, this length is preferably larger than the frame width in the vacuum machine, so that a sequence of packages can be manufactured. This frame width can be for example about 25 mm, but it depends on the structure of the vacuum machine and can of course be adjusted accordingly.

Thus it has been shown that the present invention improves the safety of handling of decoy material packages and dispensing of the decoy material. It also enables an environmentally friendly handling of the decoy material packages. The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiments is presented for purposes of illustration and description and is not intended to be exhaustive or to limit the invention to the precise form disclosed. Those skilled in the art will recognize that many changes may be made to the features of the invention described herein without departing from the spirit and scope of the invention that is defined in the appended claims.

1-15. (canceled)

16. A decoy material dispenser for a vehicle for dispensing decoy material, the dispenser comprising:
an elongated decoy material package comprising
an elongated strip-shaped container comprising a plurality of depressions configured to receive decoy material,
a cover configured to cover and hermitically seal the container, and
a gripping portion configured to cooperate with a feeder comprising a gripper; and
a housing comprising:
a storage section configured to store the decoy material package,
a dispenser outlet configured to release the decoy material,
a waste collection section configured to collect empty decoy material package,
a feeder device configured to feed the decoy material package from the storage section to the dispenser outlet and to the waste collection section, the feeder device comprising a feeder and a driver, and wherein the feeder comprises a gripper configured to cooperate with the gripping portion of the decoy material package, wherein the decoy material package is oriented in the dispenser such that the cover of the decoy material package is directed towards the dispenser outlet and the container is directed away from the dispenser outlet,
a force applicator configured to apply pressure to the container, and
a package opener configured to open, cut or perforate the decoy material package so that the decoy material stored in the decoy material package can be released from the decoy material package.

17. The dispenser according to claim 16, wherein the decoy material package further comprises an oxygen barrier.

18. The dispenser according to claim 16, wherein the depressions protrude outward from the container and have a rounded form.

19. The dispenser according to claim 16, wherein the gripping portion comprises holes or recesses that coincide with the gripper.

20. The dispenser according to claim 16, wherein the gripping portion is located in the container portion.

21. The dispenser according to claim 16, wherein the gripping portion is arranged along at least one side edge of the package.

22. The dispenser according to claim 16, wherein the waste collection section comprises a reeling unit configured to reel up the emptied decoy material package.

23. The dispenser according to claim 16, wherein the gripper comprises cogs arranged to coincide with holes or recesses of the gripping portion.

24. The dispenser according to claim 16, wherein the package opener comprises a U-shaped knife.

25. The dispenser according to claim 16, wherein the package opener is operatively connected to the dispenser outlet.

26. The dispenser according to claim 16, wherein the gripping portion is arranged along at least one side edge of the package.

27. The dispenser according to claim 16, wherein the dispenser further comprises
at least one electro-mechanical engine configured to drive at least one of the feeder or the force applicator, wherein the at least one electro-mechanical engine is coupled to a control system of the vehicle.

28. The dispenser according to claim 27, wherein the vehicle is an aircraft and dispensing of the decoy material is prevented by the control system of the vehicle when the aircraft is located on the ground.

29. A method for dispensing a decoy material, the method comprising:
feeding a decoy material package from a storage section of a dispenser utilizing a feeder device comprising a driver and feeder, wherein the feeder comprises a gripper configured to cooperate with a gripping portion of the decoy material package;
forcing utilizing a force applicator at least one individual depression at a time towards an opener;
opening, cutting or perforating the decoy material package;
releasing the decoy material from the depression utilizing the force applicator;
removing the force applicator from contact with the decoy material package;
moving the decoy material package utilizing the force applicator so that a next depression is placed in a dispense position;
moving emptied decoy material packages to a waste collection section; and
repeating until a desired amount of the decoy material has been dispensed.
